(19) United States
(12) Patent Application Publication
(10) Pub. No.: US 2011/0250316 A1
(43) Pub. Date: Oct. 13, 2011

(54) Method of manufacturing meat extract, and meat extract

(75) Inventors: Ingrid Scheide-Fischer, Summit, NJ (US); Jurgen D. Scheide, Summit, NJ (US)

(73) Assignee: Nutrition Research & Manufacturing, LLC, Summit, NJ (US)

(21) Appl. No.: 13/064,663

(22) Filed: Apr. 7, 2011

Related U.S. Application Data
(60) Provisional application No. 61/282,830, filed on Apr. 7, 2010.

(51) Int. Cl. A23L 1/313

(52) U.S. Cl. 426/56; 426/655

(57) ABSTRACT

Meat extract (warm and/or cold blooded animal) having a protein content of at least about 50% or greater and is substantially fluid or pourable at ambient temperature of about 15-25 degrees C. or more. The meat extract may have a viscosity ranging between about 1000 cP to no more than about 40000 cP for temperatures of about 20-80 degrees C. The meat extract may have a protein content of at least about 50%-about 70% with an extract moisture content of about 25%-40%, and a salt content of less than about 5%, e.g., less than 1%. The protein may have a minimum of about 22% of total essential amino acids, e.g., about 3.0% of L-Leucine and/or about 0.2% of L-Tryptophan. Also disclosed is a process of manufacturing a meat extract by extracting meat with water and at least one enzyme, e.g., a proteolytic enzyme, e.g., at least one endopeptidase (amino-endopeptidase and/or at least one carboxy-endopeptidase) and/or at least one exopeptidase, e.g., at least one amino-exopeptidase and/or at least one carboxy-exopeptidase. The extracting may takes place at an extraction temperature of between about 45° C. and about 80° C., e.g., for a period of between about 30 minutes and about 5 hours, and may be followed by subsequent heating to a temperature of between about 90° C. and about 120° C., e.g., between about 15 minutes and about 1 hour.

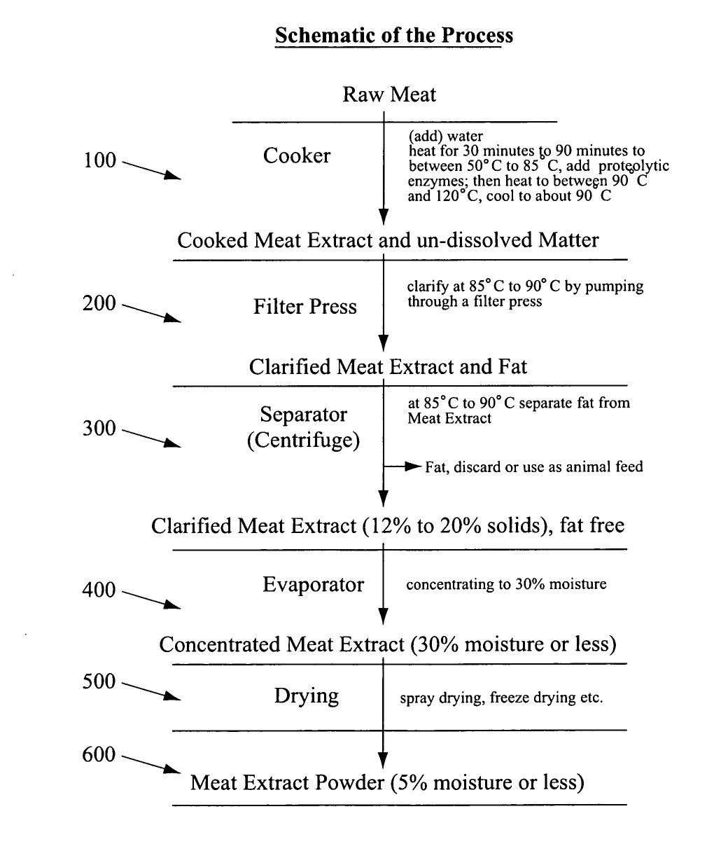

### CROSS REFERENCE TO RELATED APPLICATION

This application claims the benefit of U.S. Provisional Application No. 61/282,830, filed Apr. 7, 2010, incorporated herein by reference in its entirety.

### BACKGROUND OF TECHNOLOGY

In 1840, Justus von Liebig developed a concentrated beef extract to provide a cheap and nutritious meat substitute. Liebig's meat extract is a molasses-like black, non-fluid sticky paste that contains reduced meat stock. 3.0 kg of meat are extracted with hot water, filtered, separated from fat and then concentrated by evaporation of water. The process yields approximately 100 g of extract (3.33% of starting material).

The product is still widely used worldwide in the food and food processing industries. A typical analysis of the product is as follows:

| | |
|---|---|
| Moisture | <25% |
| Protein | 52% |
| Salt | <6% |

However, Liebig's product has substantial disadvantages, both technologically and nutritionally.

Technologically it is very difficult to handle, because of its physical properties. It must be heated in its commercial containers to at least 80° C. in order to be able to remove it for its use as food ingredient. Even then it is still a very sticky material. It cannot be fully removed from its commercial container at such high temperature, and consequently there is a substantial product loss.

Nutritionally, it only provides a small portion of the desired protein from the extracted meat material. 3.0 kg of lean beef meat, with an average fat content of 10%, contains between 0.486 kg and 0.540 kg of protein (measured as % Nitrogen multiplied by 6.25). Liebig's method of extraction only results in 0.052 kg of valuable meat protein, a 9.6% to 10.7% recovery.

### BRIEF SUMMARY OF TECHNOLOGY

An aspect of the disclosed technology is directed to a method for making a meat extract and/or a meat extract product that overcomes one or more of the above noted deficiencies.

An aspect of the technology is directed to a meat extract (warm and/or cold blooded animal) having a protein content of at least about 50% or greater and is substantially fluid or pourable at ambient temperature of about 15-25 degrees C. or more. The meat extract may have a viscosity ranging between about 1000 cP to no more than about 40000 cP for temperatures of about 20-80 degrees C.

Another aspect of the present technology is directed to a meat extract having protein content of at least about 50%-about 70%, and such protein not being hydrolyzed or not being substantially hydrolyzed, with an extract moisture content of about 25%-40%.

Another aspect of the present technology is directed to a meat extract having a protein with a minimum of about 22% of total essential amino acids in its protein, e.g., a minimum of about 3.0% of L-Leucine and/or a minimum of about 0.2% of L-Tryptophan.

Another aspect of the present technology is directed to a process of manufacturing a meat extract by extracting meat with water and at least one exogenously added enzyme, e.g., a proteolytic enzyme, e.g., at least one endopeptidase (amino-endopeptidase and/or at least one carboxy-endopeptidase) and/or at least one exogenously added exopeptidase, e.g., at least one amino-exopeptidase and/or at least one carboxy-exopeptidase. The extracting may take place at an extraction temperature of between about 45° C. and about 80° C., e.g., for a period of between about 30 minutes and about 5 hours, and may be followed by subsequent heating to a temperature of between about 90° C. and about 120° C., e.g., between about 15 minutes and about 1 hour.

The extraction process may result in a meat extract having a moisture content, a protein content and a salt content within specified ranges. For example, the moisture content may be between about 20-45%, greater than 25%, 28-40%, or 30-35%, the protein content may be in the range of 45-70%, 50-70%, 55-70% or more, 55-60%, or 53-64%, having an AN:−TN ratio of about 0.15, and the salt content may be in the range of less than 6%, e.g., less than 5%, 3% or 1%.

The extraction process may result in a recovery of protein (extracted protein/starter protein) of greater than about 15%, or 15-70%, 25-60%, 30-60%, 35-60%, 40-60%, 45-60%, 50-60%, or 55-60%.

The extraction process may result in a meat extract having high quality amino acids still in their intrinsic peptidic structure. For example the percentage of L-Leucine compared to the meat extract may be greater than 4%, 4-9%, 5-8%, 6-7.5%, and the percentage recovery of the L-Leucine in the starting material may be greater than 45%, 45-90%, 55-85%, 65-85%, 73-83%. Further the percentage of L-Tryptophan compared to the meat extract may be greater than 0.15%, 0.18-0.75%, 20-70%, 30-70%, 40-70%, 50-70%, 60-70, or 65%, and the percentage recovery of the L-Tryptophan in the starting material may be greater than 15%, 15-60%, 20-60%, 25-60%, 30-60%, 40-55%, or 48-54%.

Another aspect of the present technology is directed to a meat extract having a protein content of at least about 50% and being substantially fluid or pourable at ambient temperature of about 15-25 degrees C. or more.

Another aspect of the present technology is directed to a meat extract may have protein content of at least about 50%-about 70% with an extract moisture content of about 25%-40%.

Another aspect of the present technology is directed to a process of manufacturing a meat extract from a warm and/or cold blooded animal by extracting meat with water and at least one exogenously added proteolytic enzyme.

Another aspect of the technology is directed to a process of manufacturing a meat extract by extracting meat with water and at least one exogenously added proteolytic enzyme.

Another aspect of the technology is directed to a process of manufacturing a meat extract by extracting meat with water and at least one exogenously added endopeptidase.

Another aspect of the technology is directed to a process of manufacturing meat extract by extracting meat with water and at least one exogenously added amino-endopeptidase.

Another aspect of the technology is directed to a process of manufacturing a meat extract by extracting meat with water and at least one exogenously added carboxy-endopeptidase.

Another aspect of the technology is directed to a process of manufacturing a meat extract by extracting meat with water and at least one exogenously added amino- and/or carboxy-endopeptidase.

Another aspect of the technology is directed to a process of manufacturing a meat extract by extracting meat with water and at least one exogenously added exopeptidase.

Another aspect of the technology is directed to a process of manufacturing a meat extract by extracting meat with water and at least one exogenously added amino-exopeptidase.

Another aspect of the technology is directed to a process of manufacturing a meat extract by extracting meat with water and at least one exogenously added carboxy-exopeptidase.

Another aspect of the technology is directed to a process of manufacturing a meat extract by extracting meat with water and at least one exogenously added amino- and/or carboxy-exopeptidase.

Another aspect of the technology is directed to a process of manufacturing a meat extract by extracting meat with water and a combination of at least one exogenously added endopeptidase and at least one exogenously added exopeptidase.

Another aspect of the technology is directed to a process of manufacturing a meat extract by extracting meat with water and at least one exogenously added endopeptidase and/or exogenously added exopeptidase at an extraction temperature of between about 45° C. and about 80° C.

Another aspect of the technology is directed to a process of manufacturing a meat extract by extracting meat with water and at least one exogenously added endopeptidase and/or exogenously added exopeptidase at an extraction temperature between about 45° C. and about 80° C. and subsequent heating to a temperature of between about 90° C. and about 120° C.

Another aspect of the technology is directed to a process of manufacturing a meat extract by extracting meat with water and at least one exogenously added endopeptidase and/or exopeptidase at an extraction temperature between about 45° C. and about 80° C. for a period of between about 30 minutes and about 5 hours.

Another aspect of the technology is directed to a process of manufacturing a meat extract by extracting meat with water and at least one exogenously added endopeptidase and/or exogenously added exopeptidase at extraction temperatures between about 45° C. and about 80° C. and subsequent heating to temperatures between about 90° C. and about 120° C. for a period of between about 15 minutes and about 1 hour.

Another aspect of the technology is directed to a process of manufacturing a meat extract by extracting meat from a warm-blooded animal with water and at least one exogenously added proteolytic enzyme.

Another aspect of the technology is directed to a process of manufacturing a meat extract by extracting meat from a cold-blooded animal with water and at least one exogenously added proteolytic enzyme.

Another aspect of the technology is directed to a process of manufacturing a meat extract by extracting meat from a warm-blooded or cold-blooded animal with water and at least one exogenously added proteolytic enzyme, and subsequent clarification and/or fat-separation of the extract.

Another aspect of the technology is directed to a process of manufacturing a meat extract by extracting meat from a warm-blooded or cold-blooded animal with water and at least one exogenously added proteolytic enzyme, subsequent clarification and/or fat-separation of the extract, and concentration of the extract by water evaporation.

Another aspect of the technology is directed to a process of manufacturing a meat extract in which the protein is not hydrolyzed, or substantially not hydrolyzed. In one example, water and extract are mixed during a specific time duration, e.g., an hour or less or less than one hour.

Another aspect of the technology is directed to a meat extract having a protein content of between about 55% to about 59% at an extract moisture content of about 35%, and between about 62% to about 66% at an extract moisture content of about 30%.

Another aspect of the technology is directed to a meat extract that is pourable at room temperature. For example, the meat extract may have a viscosity of between about 30,000 and about 36,000 cP (mPa·s) at about 20° C., and between about 2,500 and about 3,500 cP (mPa·s) at about 50° C., and/or less than about 2,000 cP (mPa·s) at about 80° C.

Another aspect of the technology is directed to a meat extract with moisture content of about 30% having a minimum of about 22% of total essential amino acids in its protein.

Another aspect of the technology is directed to a meat extract with moisture content of about 30% having a minimum of about 3.0% of L-Leucine in its protein.

Another aspect of the technology is directed to a meat extract with a moisture content of about 30% having a minimum of about 0.2% of L-Tryptophan in its protein.

Another aspect of the technology is directed to a meat extract with a moisture content of about 30% having a minimum of about 3.0% of L-Leucine and a minimum of about 0.2% of L-Tryptophan in its protein.

Another aspect of the technology is directed to a meat extract with a moisture content at about 30% having a minimum of about 22% total essential amino acids, and a minimum of about 3.0% L-Leucine in its protein.

Another aspect of the technology is directed to a meat extract with a moisture content at about 30% having a minimum of about 22% total essential amino acids, and a minimum of about 0.2% L-Tryptophan in its protein.

Another aspect of the technology is directed to a meat extract with a moisture content at about 30% having a minimum of about 22% total essential amino acids, and a minimum of about 3.0% L-Leucine and a minimum of about 0.2% L-Tryptophan in its protein.

Another aspect of the technology is directed to a meat extract as described above being converted into a powder form by either spray drying, freeze drying or other known methods of drying.

### BRIEF DESCRIPTION OF THE SOLE DRAWING

The sole FIGURE is a schematic diagram illustrating a process according to the present technology.

### DETAILED DESCRIPTION OF TECHNOLOGY

The following description is provided in relation to several examples that may share at least one common characteristic and/or feature. It is to be understood that one or more features of any one example may be combinable with one or more features of the other examples. In addition, any single feature or combination of features in any of the examples may constitute additional examples.

Surprisingly, it has been found that a much higher amount of protein can be extracted, as compared to Liebig's method, if the extraction of meat with water is aided by the use of incidental amounts of at least one exogenously added enzyme, e.g., a proteolytic enzyme. The increase in extracted protein is greater as compared to Liebig's method, e.g., more than about 5% greater, e.g., greater than about 20%, about 30%, about 40%, about 50%, about 60%, about 70%, about 80%, about 90%, about 100%, and/or up to about 5%-400% greater or more (up to 4 fold or more), e.g., about 5%-100%, about 75%-150%, about 100%-200%, about 150%-300%, about 250%-400%, or about 300%-400%. In addition, the protein in the concentrated product is not hydrolyzed, or not substantially hydrolyzed, and the concentrated product is still substantially free-flowing, fluid or pourable at ambient temperature (about 15-25, or 20° C.).

The example proteolytic enzyme may be of the class of endopeptidases and exopeptidases, [aminopeptidases and carboxypeptidases], either combined or individual. These peptidases can be derived from animal or plant (including bacteria and/or fungi) origin. Examples of such enzymes are papain, bromelain, trypsin, pepsin, kathepsin etc.

It has been found that this new process can be applied not just to beef, but also to meat of all warm-blooded animals, domesticated and/or wild living. Of particular interest is meat from cattle, hogs, poultry, buffalo, elk, deer, moose and fowl. It also might be mentioned that this new process can be used for the extraction of meat protein from cold-blooded animals.

Description of Example Process

As shown in the example process schematically illustrated in the sole FIGURE, in a first step 100, meat (raw and/or cooked) together with water are placed into extraction equipment (e.g., cooker), and heated at an extraction temperature, e.g., for about 30 minutes to between about 50 to about 85 degrees C. At least one enzyme, e.g., proteolytic enzyme, is added, when the meat is first added or after the meat is placed in the cooker. The mixture is heated to between about 90 to 120 degrees C., which is allowed to cool to about 90 degrees C.

This results in a cooked meat extract and un-dissolved matter, which is clarified in step 200, e.g., by pumping the mixture through a filter press held at a temperature of about 85-90 degrees C. This results in clarified meat extract and fat.

In step 300, the fat is separated, e.g., using a separator or centrifuge, while held at a temperature of about 85-90 degrees C. The fat is discarded or can be used as animal feed. The result is a clarified meat extract having a solids content of about 12 to about 20% (essentially fat free).

In step 400, the meat extract is subject to an evaporation process, which results in a concentrated meat extract, e.g., with a moisture content of 30% or less.

In step 500, the meat extract may be subject to drying, e.g., spray, freeze drying, etc. This may result in a meat extract powder having a moisture content of 5% or less.

In relation to the above “steps” it should be noted that various ones of these steps or aspects thereof can be combined or eliminated. Moreover, various ones of the steps may be performed at different times or sequentially, in different orders, or they may be performed simultaneously.

In one specific example, meat (raw or cooked) is provided, and between about 10% and about 20% water and between about 0.1% to about 0.5% exogenously added enzyme, e.g., one or more exogenously added proteolytic enzymes, are added. The mix is heated under agitation to a temperature, e.g., between about 45° C. and about 80° C. for a period of between about 30 minutes and about 5 hours. In one example a time from about 40 to about 60 minutes is applied. Thereafter, the meat extract slurry is heated to a temperature between about 90° C. to about 120° C. to inactivate enzymes and increase extract yield. The extract is clarified from all insoluble material by means of filtration or mechanical separation device.

In a further process step the meat extract is separated from its animal fat. In a next or final process step the fat-free and clarified extract is concentrated by water evaporation to a solids' content of between about 65% and about 70%. Surprisingly, even at that concentration these novel meat extracts are fluid or pourable at ambient temperature, e.g., about 15-25 degrees C., or about 20 degrees C.

Their protein content varies from approximately 55% to approximately 65%, respectively.

### Example 1

360.0 kg of Ground beef (32% fat) are placed into a
jacketed blender with
40.0 kg of Water and
1.0 kg of Papain enzyme [an endopeptidase], e.g.,
Purified Papain RS 600 (Activity: 600 TU/mg); Enzyme
Development Corporation, 21 Penn Plaza, New York, NY 10001.

Under agitation the mixture is heated to about 65° C. and held for about 45 minutes. The mixture then is heated to about 95° C., held for about 10 minutes and pumped through a filter press. The clarified extract is separated from its fat in a centrifuge. The final process step involved concentration by water evaporation in a falling film evaporator. About 41.3 kg of concentrated beef extract were recovered (about 11.5% of starting material).

The resulting beef extract concentrate has a typical analysis as follows:

| Moisture | about 34.5% |
|---|---|
| Protein | about 57.4% |
| Salt | <1.0% |

The protein content of the starting beef meat was analyzed as about 14.9%. Thus the starting material contained about 53.6 kg of valuable beef protein. The recovered amount of beef protein in the extract represents about 23.7 kg, a protein extraction efficiency of about 44.2%.

### Example 2

360.0 kg of Ground beef (32% fat) are placed into a
jacketed blender with
22.0 kg of Water and cooked under agitation at 80° C.
for 30 minutes. The mixture is cooled with
47.0 kg of ice-cold Water to 50° C. and then
0.6 kg Papain enzyme and
1.0 kg of Protease M [an exopeptidase mixture] are
added, e.g., Protease M (Activity: 5,500 u/g); Amano Enzyme
USA Co., 2150 Point Blvd., Elgin, IL 60123.

The extraction takes place at about 50° C. to 52° C. for about 50 minutes, and then is continued at about 120° C. for about another 15 minutes. After cooling to about 90° C. the extract is pumped through a filter press. The clarified extract is separated from its fat in a centrifuge. About 220.0 kg of clarified and fat-free beef extract were received. It had a moisture content of approximately 83%.

The final process step involved concentration by water evaporation in a falling film evaporator. 45.3 kg of concentrated beef extract were recovered (12.6% of starting material).

The resulting beef extract concentrate has a typical analysis as follows:

| Moisture | about 30.1% |
|---|---|
| Protein | about 63.8% |
| AN:-TN ratio of protein | about 0.16 |
| Salt | <1% |

The protein content of the starting beef meat was analyzed as about 14.9%. Thus the starting material contained 53.6 kg of valuable beef protein. The recovered amount of beef protein in the extract represents 28.9 kg, a protein extraction efficiency of about 53.9%.

### Example 3

300.0 kg of Mechanically Separated Chicken Meat (23.4% fat) and
20.0 kg Water are cooked under agitation in a jacketed blender at 80° C.
for 30 minutes. The mixture is cooled with
40.0 kg of ice-cold Water to 50° C. and then
0.5 kg Papain enzyme and
0.8 kg of Protease M are added, e.g., Protease M (Activity: 5,500 u/g);
Amano Enzyme USA Co., 2150 Point Blvd., Elgin, IL 60123.

The extraction takes place at about 50° C. to 52° C. for about 50 minutes, and then is continued at about 120° C. for about another 30 minutes. After cooling to about 90° C. the extract is pumped through a filter press. The clarified extract is separated from its fat in a centrifuge. About 200.0 kg of clarified and fat-free chicken extract were received. It had a moisture content of approximately 87%.

The final process step involved concentration by water evaporation in a falling film evaporator. About 41.5 kg of concentrated chicken extract were recovered (about 13.8% of starting material).

The resulting chicken extract concentrate has a typical analysis as follows:

| Moisture | about 35.0% |
|---|---|
| Protein | about 55.8% |
| AN:-TN ratio of protein | about 0.14 |
| Salt | <1% |

The protein content of the starting chicken meat was analyzed as about 13.2%. Thus the starting material contained about 39.6 kg of valuable chicken protein. The recovered amount of chicken protein in the extract represents about 23.2 kg, a protein extraction efficiency of about 58.6%.

In one example, a process for manufacturing one or more meat extracts is achieved by extracting meat with water and one or more enzymes. For example, the enzyme may be a proteolytic enzyme (or enzymes) in the form of an exogenously added enzyme that is added to the meat that is to be extracted. As stated above, proteolytic enzyme may be from any source including, at least, enzyme of animal or plant origin or a mixture of animal and/or plant enzymes. The enzyme may be a partially purified or purified enzyme or a mixture of purified or partially purified enzymes. The exogenously added enzyme may be from about 0.05% to about 1% of the reaction such as, for example, from about 0.1% to about 0.5% of the reaction.

Another preferred embodiment is directed to a meat extract with a protein concentration of greater than about 55% or greater than about 60%. Such an extract may have, for example, a protein content of between about 55% and about 65%. The meat extract may preferably have a moisture content of less than about 40%, less than about 35% or less than about 30%. In addition, the meat extract may have a salt content of less than about 1%.

Example Technological Advantage of the Process:

One advantage of the process is shown in the physical properties in Table 1, which refers to the viscosity of conventional meat extract compared to the product of the present technology. The viscosity was measured at 20° C., 50° C. and 80° C., in mPa·s (cP) Units (see Table 1).

TABLE 1

| | | | LOQ |
|---|---|---|---|
| | Viscosity | Units | Mm = 100; |
| | at | mPa · s (cP) | Max = 2M*) |
| Conventional | 20° C. | >max | |
| Meat Extract | 50° C. | 475764 | Min = 100 |
| | 80° C. | 23642 | Min = 100 |
| MeatExtract | 20° C. | 34149 | Min = 100 |
| technology | 50° C. | 2942 | Min = 100 |
| example | 80° C. | 1140 | Min = 100 |

Explanation:
Min = 100 cP
*)Max = 2000000 cP
LOQ = the limit of quantitation- concentration at which quantitative results can be reported with a high degree of confidence

Discussion of results. Conventional meat extract does not flow and has no easily measurable viscosity at 20° C. (ambient temperature). At 50° C. it is still not flowing with a viscosity of 475764 cP. At 80° C. it is slow flowing with 23642 cP.

In comparison, the meat extract of one or more examples of the present technology is generally flowable or fluid at ambient temperature (e.g. 15-20 degrees C.) or above. For example, at 20° C., the meat extract is slow flowing with a viscosity of 34149 cP; at 50° C. it is easy flowing with a viscosity of 2942 cP; and at 80° C. it is very easy flowing with a viscosity of 1140 cP. Generally, examples of the present technology demonstrate a viscosity of about 1000 cP to no more than about 40000 cP at temperatures above about 20 degrees C., meaning it is substantially fluid or easily pourable from its container.

The extract of this example of the technology can be very easily handled and removed from its containers at a moderately increased temperature above room temperature. This avoids substantial loss of product and increases its commercial value.

Nutritional Advantages of the Process

Meat proteins have a very high nutritional value. Beef protein contains all Essential Amino Acids. Pure beef meat muscle has the following average content of nutrients:

TABLE 2

| | |
|---|---|
| Protein | 22.0% |
| Fat | 1.9% |
| Available Carbohydrates | 1.0% |
| Minerals | 1.2% |
| Moisture | 74.0% |

The contents of essential amino acids is as follows:

| | % in meat | % in available protein |
|---|---|---|
| L-Isoleucine | 1.25 | 5.68 |
| L-Leucine | 1.95 | 8.86 |
| L-Lysine | 2.31 | 10.50 |
| L-Methionine | 0.65 | 2.95 |
| L-Phenylalanine | 1.06 | 4.81 |
| L-Threonine | 1.15 | 5.23 |
| L-Tryptophane | 0.29 | 1.32 |
| L-Valine | 1.32 | 6.00 |

The meat extract of Example 2 was analyzed for its content of essential amino acids and compared to the essential amino acids content of a commercially available beef extract. The results were as follows:

TABLE 3

| | Commercial | Extract of |
|---|---|---|
| | Beef extract* | Example 2 |
| Total protein | 51.7 | about 63.8 |
| (% of extract) | | |
| | % amino | % amino |
| | acid in protein | acid in protein |
| L-Isoleucine | 1.76 | about 3.59 |
| L-Leucine | 3.66 | about 7.19 |
| L-Lysine | 6.42 | about 7.93 |
| L-Methionine | 1.28 | about 2.15 |
| L-Phenylalanine | 1.59 | about 3.47 |
| L-Threonine | 1.95 | about 3.47 |
| L-Tryptophan | 0.14 | about 0.65 |
| LValine | 2.47 | about 4.86 |

*Delta Beef Extract, Organic #IFP-1-21; EFP Enterprise Food Products LLC, P.O. Box 833, Nyack, NY 10960

Discussion of Results:

The protein of one or more extracts of the technology has an AN:−TN ratio of not higher than 0.16. This indicates that the protein of examples of the technology is not hydrolyzed. It is desirable for the nutritional quality, that the protein in the extract (e.g., beef extract), is not hydrolyzed. A status of hydrolyzation is achieved, according to the Food and Drug Administration, if the AN:−TN ratio is 0.46 or larger (=fully hydrolyzed), the AN:−TN ratio is 0.23 or larger (=mildly hydrolyzed), where AN=Amino Nitrogen (representing free amino acids), and TN=Total Nitrogen (representing all amino acids).

Amino acids in their free state are easily subject to react in a Maillard Reaction and are thus no longer available as nutrients. The protein of the extract of one or more examples of the technology has an AN:−TN ratio of about 0.14 to about 0.16, or not higher than 0.18. This indicates that the protein of the technology is not hydrolyzed. The protein is also considered to be less than mildly hydrolyzed (e.g., AN:−TN less than 0.23).

The analysis of essential amino acids in the protein of commercial beef extract in comparison to the product of the example technology clearly shows that the protein of the commercial extract is inferior to the protein of the example product. The concentration of individual essential amino acids in its protein is significantly lower than the concentration of individual essential amino acids in the protein of the product of Example 2. This is quite evident if one compares two very important essential amino acids, L-Leucine and L-Tryptophan.

The amount of these two amino acids extracted from the meat protein and its concentration in the resulting meat extract are much higher in the product of the example technology when compared to commercial extracts.

L-Leucine:

The theoretical amount of L-Leucine in protein of pure beef meat muscle is 8.86% (as described in Table 2)

Based on the analysis, the commercial beef extract contains 3.66% L-Leucine in the protein, a recovery of only 41%.

In contrast, the extract of the example technology contains about 7.19% L-Leucine in the protein, a recovery of about 81%.

L-Tryptophan:

The theoretical amount of L-Tryptophan in protein of pure beef meat muscle is 1.32% (as described in Table 2).

Based on the analysis, the commercial beef extract contains 0.14% L-Tryptophan in the protein, a meager recovery of only 10.6%. In contrast, the extract of the example technology contains about 0.65% L-Tryptophan in the protein, a recovery of 51%.

L-Tryptophan is very desirable for the production of serotonin, a key brain neurotransmitter. Of even desirability is the function of this essential amino acid in the production of melatonin, a neurohormone. However, L-Tryptophan is very sensitive to any kind of harsh processing conditions, such as high temperature, and pH. It is easily destroyed or partially destroyed, especially at acidic conditions and high temperatures. The analytical results clearly demonstrate that the manufacturing conditions of the example technology are superior to the process of the commercial products, because the recovery of L-Tryptophan is almost five times as high in the example technology.

Nutritional research in the field of muscle biology has discovered the cellular mechanism that regulates the ratio of protein synthesis/protein breakdown. The key muscle building mechanism in all mammals depends on a complex protein called mTOR (mammalian target of rapamycin), which is part of the insulin pathway. mTOR increases protein synthesis in myofibrils and eventually leads to increased muscle size.

For an aging population human fitness, at least in part, depends both on exercise as well as on a high protein low carbohydrate diet. It is very desirable that the protein diet is based on the availability of all essential amino acids. Among them L-Leucine, one of the three branch chain amino acids, plays a predominant role. L-Leucine signals the muscle to increase protein synthesis even during times of food restriction or after prolonged physical hardship. It is the sheer increase in circulating L-Leucine concentration that triggers the mTOR.

Based on nitrogen-balance measurements, the human requirements for L-Leucine to maintain body protein is 1-3 g daily, depending on weight. To optimize the anabolic pathway, it is estimated that L-Leucine requirement should be about 8 g-16 g daily. This means that an adult should consume between 425 g-842 g (1 lb-2 lb) of lean beef daily (with an average of 1.9 g L-Leucine per 100 g). It is unlikely that people would consume that much meat every day. In contrast, if the extract of present technology was available that high L-Leucine intake would be possible. At about 63.8% protein with a L-Leucine content of 7.19%, only 65 g (2.3 oz) daily of protein nutrition is necessary to optimize the anabolic pathway. In particular the elderly population would be provided with a sound nutrient system to maintain a healthy muscle mass. The product of the example technology would be equally effective for reconvalescence after surgery.

Spray drying and freeze drying are well known technologies to convert liquid food products into a powder form. The available amount of L-Leucine in the extract of the example technology could further be enhanced by converting the liquid extract into a powder form, which would contain 95%-97% protein.

Thus about 120 g (about 4.2 oz) of this beef extract powder provides about 8.5 g of L-Leucine.

While the technology has been described in connection with what are presently considered to be the most practical and preferred examples, it is to be understood that the technology is not to be limited to the disclosed examples, but on the contrary, is intended to cover various modifications and equivalent arrangements.

1. Meat extract having a protein content of at least about 50% and being substantially fluid or pourable at ambient temperature of about 15-25 degrees C. or more.

2. Meat extract of claim 1, wherein the meat extract has a viscosity ranging between about 1000 cP to no more than about 40000 cP for temperatures of about 20-80 degrees C.

3. Meat extract of claim 2, wherein the viscosity is between about 30,000 and about 36,000 cP (mPa·s) at about 20° C.

4. Meat extract of claim 2, wherein the viscosity is between about 2,500 and about 3,500 cP (mPa·s) at about 50° C.

5. Meat extract of claim 2, wherein the viscosity is less than about 2,000 cP (mPa·s) at about 80° C.

6. Meat extract may have protein content of at least about 50%-about 70% with an extract moisture content of about 25%-40% and a salt content of less than 5%, the protein not being hydrolyzed or not being substantially hydrolyzed.

7. Meat extract of claim 6, wherein the protein content is between about 55% to about 59% at an extract moisture content of about 35%, and wherein a ratio of AN:−TN is about 0.14 to about 0.16, where AN=Amino Nitrogen (representing free amino acids) and TN=Total Nitrogen (representing all amino acids).

8. Meat extract of claim 6, wherein the protein content is between about 62% to about 66% at an extract moisture content of about 30%.

9. Meat extract of claim 6, wherein the meat extract has a protein including a minimum of about 22% of total essential amino acids in its protein.

10. Meat extract of claim 9, wherein the total essential amino acids includes a minimum of about 3.0% of L-Leucine and/or a minimum of about 0.2% of L-Tryptophan.

11. A process of manufacturing a meat extract from a warm and/or cold blooded animal by extracting meat with water and at least one exogenously added proteolytic enzyme.

12. Process of claim 11, wherein the enzyme includes at least one endopeptidase and/or at least one exopeptidase.

13. Process of claim 12, wherein the endopeptidase includes at least one amino-endopeptidase and/or at least one carboxy-endopeptidase.

14. Process of claim 12, wherein the enzyme includes at least one exopeptidase.

15. Process of claim 14, wherein the exopeptidase includes at least one amino-exopeptidase and/or at least one carboxy-exopeptidase.

16. Process of claim 12, wherein the at least one enzyme includes a combination of at least one endopeptidase and at least one exopeptidase.

17. Process of claim 11, wherein the enzyme includes at least one peptidases derived from animal or plant, including bacteria and/or fungi origin.

18. Process of claim 17, wherein the enzyme includes, papain, bromelain, trypsin, pepsin, and/or kathepsin.

19. Process of claim 11, wherein the extracting takes place at an extraction temperature of between about 45° C. and about 80° C.

20. Process of claim 19, wherein the extracting at the extraction temperature takes place for a period of between about 30 minutes and about 5 hours.

21. Process of claim 19, further comprising subsequent heating to a temperature of between about 90° C. and about 120° C.

22. Process of claim 21, wherein the subsequent heating is applied for a period of between about 15 minutes and about 1 hour.

23. Process of claim 21, further comprising subsequent clarification and/or fat-separation of the meat extract.

24. Process of claim 23, further comprising concentrating the meat extract by water evaporation.

25. Process of claim 24, further comprising converting the meat extract into powder form by either spray drying, freeze drying or other known methods of drying.
